(19) United States
(12) Patent Application Publication
(10) Pub. No.: US 2020/0187699 A1
(43) Pub. Date: Jun. 18, 2020

(54) Divided Cooking Device with a Lid

(71) Applicants: Lisa Graybeal, Mooresville, NC (US); Michael Mayfield, Huntersville, NC (US)

(72) Inventors: Lisa Graybeal, Mooresville, NC (US); Michael Mayfield, Huntersville, NC (US)

(73) Assignee: Lisa Graybeal, Mooresville, NC (US)

(21) Appl. No.: 16/716,665

(22) Filed: Dec. 17, 2019

Related U.S. Application Data
(60) Provisional application No. 62/780,465, filed on Dec. 17, 2018.

(51) Int. Cl. A47J 27/122; A47J 36/06; A47J 36/20; A47J 27/00; A47J 37/10

(52) U.S. Cl. CPC A47J 27/122; A47J 36/06; A47J 37/101; A47J 27/002; A47J 36/20

(57) ABSTRACT

A divided cooking device with a lid including a base having at least one side wall rising vertically from the base. The base and the at least one sidewall create an interior volume. A plurality of dividers is located within the interior volume such that each divider rises vertically from the base. The dividers connect to the at least on sidewall and create a plurality of different cooking sections. The different cooking sections have a combination of different cooking surfaces and cooking materials. The device has a lid that is configured to fit around the top edge of the at least one side wall.

### CROSS REFERENCE TO RELATED APPLICATIONS

This application claims the benefit of U.S. Provisional Application No. 62/780,465 filed on Dec. 17, 2018. The above identified patent application is herein incorporated by reference in its entirety to provide continuity of disclosure.

### BACKGROUND OF THE INVENTION

The present invention relates to separated cooking devices. More particularly, the present invention provides a divided cooking device with a lid.

Many people either enjoy cooking car cook food out of necessity. When cooking, it is often necessary to cook multiple different foods at once or to cook the same food in different manners. For example, when cooking eggs for multiple different individuals it is seldom the case that everyone wants the same style of eggs. This means that an individual will have to use multiple different pans or continuously clean the same pan for re-use.

This process can be extremely time consuming and could make it impossible for every meal to be completed on time. Traditional pans will not allow a person to cook many different foods or different styles of food in the same pan. Further, when cooking in a pot with liquids it is impossible to keep the different types of liquids separate. On various occasions a chef will need to cook multiple different types of liquids at the same time. Further, it may be required to cook different pastas at a different time to ensure that the pasta is done at the correct time.

Consequently, there is a need in for an improvement in the art of cooking different foods simultaneously. The present invention substantially diverges in design elements from the known art while at the same time solves a problem many people face when cooking different foods or cooking the same food in different ways. In this regard the present invention substantially fulfills these needs.

### SUMMARY OF THE INVENTION

The present invention provides a divided cooking device with a lid wherein the same can be utilized for providing convenience for the user when simultaneously preparing multiple food items in multiple styles. The divided cooking device includes a cooking pan having a base and at least one vertical side all, creating an interior area. A plurality of vertical dividers is located within the interior area, wherein the dividers create a plurality of cooking areas. There is at least one handle connected to the at least on side wall.

One object of the present invention is to provide a divided cooking device having a different cooking material located in each of the plurality of cooking areas.

Another object of the present invention is to provide a divided cooking device having a different cooking surface located in each of the plurality of cooking areas.

A further object of the present invention is to provide a divided cooking device including at least one grill top cooking surface.

Yet another object of the present invention is to provide a divided cooking device including at least one non-stick pan surface.

Still a further object of the present invention is to provide a divided cooking device having a lid configured to fit about the top of the at least one sidewall.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the divided cooking device.

FIG. 2 shows a perspective view of an embodiment of the divided cooking device with different cooking surfaces.

FIG. 3 shows a perspective view of an embodiment of the divided cooking device with different cooking materials in each section.

FIG. 4 shows a perspective view of an embodiment of the divided cooking device with a lid.

FIG. 5 shows a perspective view of an embodiment of the divided cooking device with a strainer.

### DETAILED DESCRIPTION OF THE INVENTION

Reference is made herein to the attached drawings. Like reference numerals are used throughout the drawings to depict like or similar elements of the divided cooking device with a lid. For the purposes of presenting a brief and clear description of the present invention, a preferred embodiment will be discussed as used for simultaneously preparing foods in different styles within isolated cooking areas. The figures are intended for representative purposes only and should not be considered to be limiting in any respect.

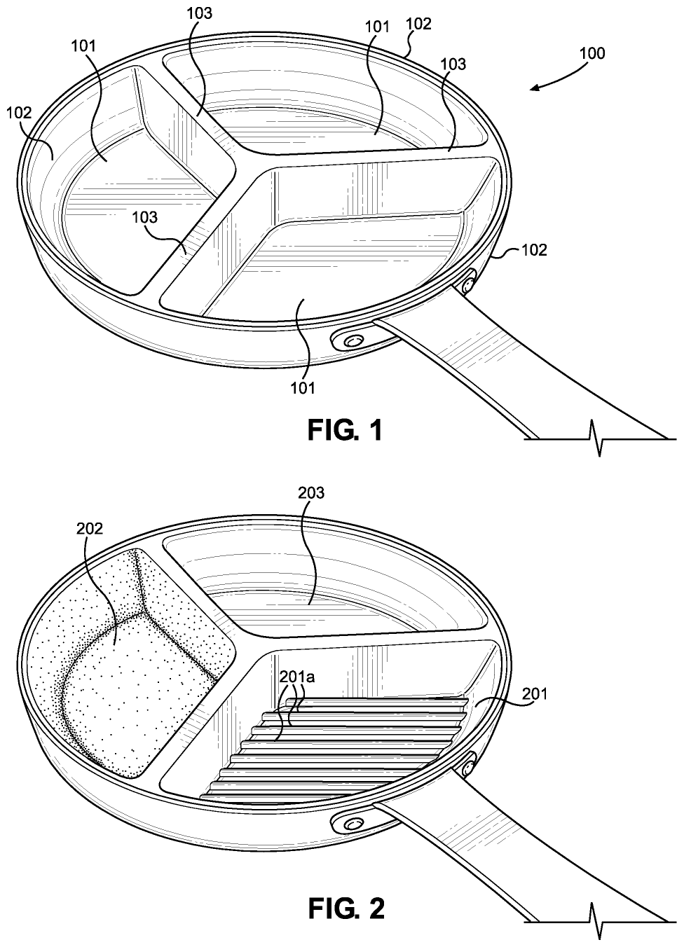

Referring now to FIG. 1, there is shown a perspective view of an embodiment of the divided cooking device. In one embodiment, the divided cooking device is a skillet 100. The skillet 100 has a base 101. The base 101 is made from a cooking appropriate material. In one embodiment, the base 101 is made from steel. In another embodiment, the base 101 is made from iron. The base 101 has at least one sidewall 102 attached to the base 101 and extending upwardly therefrom in a generally vertical orientation. The at least one sidewall 102 will rise above the base 101 creating an interior volume. In one embodiment, the sidewall 102 is made from the same material as the base 101. In another embodiment, the sidewall 102 is made from a different material than the base 101.

The divided cooking device has a plurality of dividers 103 placed within the interior volume. Each divider 103 extends upwardly from the base 101 at a generally vertical angle. Each divider 103 includes a planar rectangular shape having four edges. Each divider of the plurality of dividers 103 has an edge connected to the base 101. Each of the dividers 103 further includes an edge connected to the at least one side wall 102. In one embodiment, each divider 103 includes at least one edge that is connected to another divider 103. In another embodiment, each divider 103 includes another edge that is connected to another portion of the at least one sidewall 102.

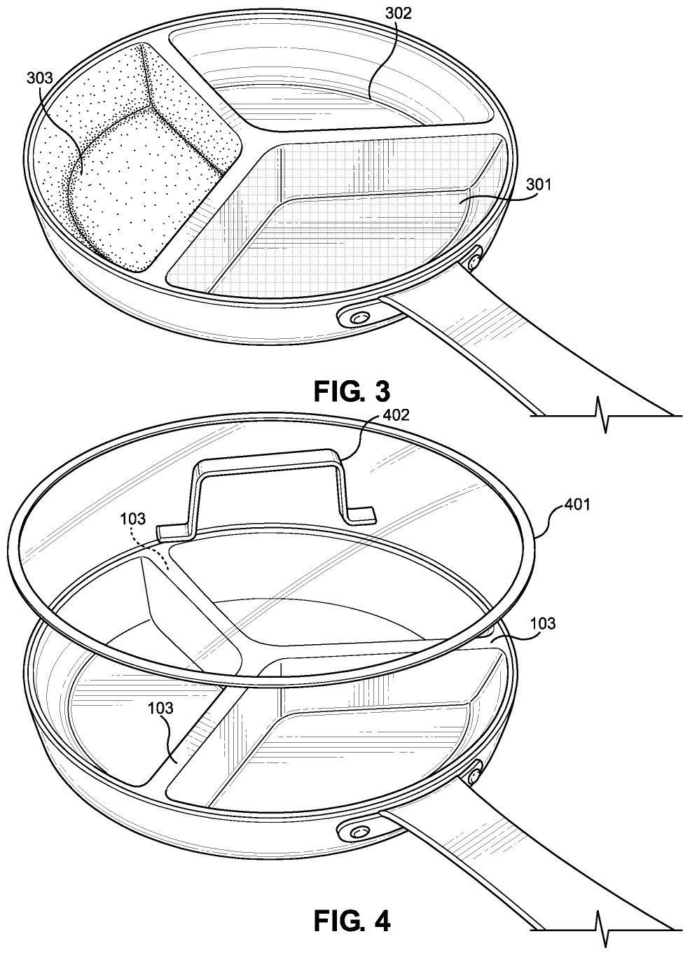

Referring now to FIG. 2, there is shown a perspective view of an embodiment of the divided cooking device with different cooking surfaces. In one embodiment of the divided cooking device, the cooking device has different cooking surfaces located between each division defined by adjacent dividers. In one embodiment, there can be a combination of different surfaces located in each division. In one embodiment at least one surface is a grill surface 201. This a grill surface will have parallel raised portions that define recessed parallel channels 201a. In another embodiment, the divided cooking device has a an omelet section 202, which may include a non-stick surface. The omelet section 202 can include a smaller area than the remaining divided sections, which provides a smaller shape to keep eggs formed for proper cooking consistency. In a further embodiment, the dividing cooking device includes a flat skillet section 203. The flat skillet section 203 may include a non-stick surface or may include another surface. In another embodiment there is a stainless steel material may be used in at least on of the sections.

Referring now to FIG. 3, there is shown a perspective view of an embodiment of the divided cooking device with different cooking materials in each section. In one embodiment, a divided section has a cast iron cooking material 301. In another embodiment, a divided section has a stainless steel cooking material 302. In a further embodiment, a divided section has a non-stick cooking material 303. In yet another embodiment, a divided cooking section has a copper cooking material. It can be difficult to cook different ingredients in the same type material. Further, ingredients may need to be cooked differently but all cooked at the same time to be combined at once. It is beneficial to be able to cook in different ways all in the same pan.

Referring now to FIG. 4, there is shown a perspective view of an embodiment of the divided cooking device with a lid. In one embodiment, the plurality of dividers 103 are configured to only be as tall as the at least one sidewall. In this embodiment, a lid 401 can be placed over the divided cooking device. In one embodiment, the lid 401 includes a flat surface. In another embodiment, the lid 401 includes a domed surface. The lid 401 has a knob or handle 402 attached to the top side thereof. This will allow for the lid 401 to be safely removed. In one embodiment, the lid 401 is composed of glass. In another embodiment, the lid 401 is composed of metal. In some embodiments, the lid 401 is composed of a combination of glass and metal.

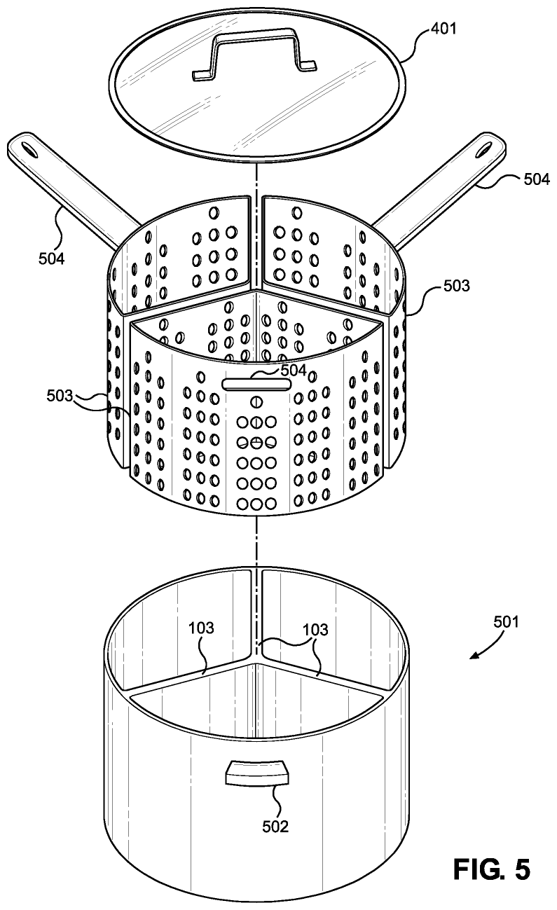

Referring now to FIG. 5, there is shown a perspective view of an embodiment of the divided cooking device with a strainer. In one embodiment, the divided cooking device is a soup pot 501. The soup pot 501 is a larger pot and has the ability to hold solids as well as liquids. The soup pot 501 has a pair of handles 502 located close to the top open section of the soup pot 501. This embodiment of the divided cooking device has dividers 103 that are configured to separate the soup pot 501 into individual compartments. This will allow a user to cook three different things in the pot at one time without mixing them together.

In the soup pot 501 embodiment there is a plurality of cooking strainers 503 that are configured to fit within the sections of the soup pot 501. Each of the cooking strainers 503 has a plurality of apertures placed therein. A handle 504 is attached to a top side of each cooking strainer 503. The cooking strainers 503 are configured to be placed within the sections of the soup pot 501 and then have a food product placed within the strainer 503 and the pot 501. The food will be cooked in the soup pot 501, the strainer 503 can then be removed to retrieve the cooked food without its cooking liquid. This will allow a user remove one item without dumping all three sections of the soup pot 501.

In one embodiment, the divided cooking device is configured to have a strainer 503 placed within each of the divided sections. The strainer 503 will be configured to be placed within the divided section then to have pasta or an item to be cooked placed within the strainer 503 within the divided section. This will allow for the item to be cooked within the strainer 503. The strainer 503 will have a handle 504 attached to an upper lip thereof. The handle 504 will stick out over the at least one sidewall of the soup pot 501.

The soup pot 501 has a lid 505 that is configured to be placed on the top of the soup pot 501. In one embodiment, the same lid 401 configuration that is used for the frying pan or skillet is configured to fit the soup pot 501. In one embodiment, the lid 401 is configured to be placed on the soup pot 501 with the strainer 503 placed therein. In another embodiment, the lid 401 is configured to fit directly about an upper edge of the at least one sidewall of the soup pot 501.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A divided cooking device, comprising:
a cooking pan having a base and at least one vertical sidewall, creating an interior area;
a plurality of vertical dividers located within the interior area, wherein the dividers create a plurality of cooking areas;
at least one handle connected to the at least one side wall.

2. The divided cooking device of claim 1, further comprising a different cooking material located in each of the plurality of cooking areas.

3. The divided cooking device of claim 1, further comprising a different cooking surface located in each of the plurality of cooking areas.

4. The divided cooking device of claim 1, wherein one of the cooking surfaces is a grill top cooking surface.

5. The divided cooking device of claim 1, wherein one of the cooking surfaces is a non-stick pan surface.

6. The divided cooking device of claim 1, further comprising a lid configured to fit about a top of the at least one sidewall.

7. A divided cooking device, the device comprising:
A cooking pot having a base and at least one vertical sidewall, creating an interior area;
A plurality of vertical dividers located within the interior area, wherein the dividers create a plurality of cooking areas;
There is at least one handle connected to the at least on side wall;
a removable strainer is located within each cooking area, wherein each strainer of the plurality of strainers is configured to fit in one divided cooking area of the plurality of divided cooking areas.

8. The divided cooking device of claim 7, further comprising a lid configured to fit about a top of the at least one sidewall.

9. The divided cooking device of claim 7, further comprising a different cooking material located in each of the plurality of cooking areas.

10. The divided cooking device of claim 7, further comprising a different cooking surface located in each of the plurality of cooking areas.
